(19) United States
(12) Patent Application Publication
(10) Pub. No.: US 2009/0039858 A1
(43) Pub. Date: Feb. 12, 2009

(54) DIRECT CURRENT POWER SUPPLY DEVICE

(75) Inventor: Shogo Hachiya, Fukuoka (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 11/911,834

(22) PCT Filed: Mar. 3, 2006
(86) PCT No.: PCT/JP2006/304148

§ 371 Date: Oct. 18, 2007

(30) Foreign Application Priority Data
Apr. 18, 2005 (JP) 2005-120365

(51) Int. Cl. G05F 5/00

(52) U.S. Cl. 323/299

(57) ABSTRACT

A direct-current power supply apparatus outputs a predetermined output voltage by lowering an input voltage. The apparatus includes a control element to which the input voltage is inputted, a first resistive element, provided in series with the control element, which outputs the output voltage, and second and third resistive elements, connected in series with each other, which are provided in parallel with the first resistive element. A voltage at a midpoint between the second resistive element and the third resistive element is fed back so as to control the control element.

### TECHNICAL FIELD

The present invention relates to a DC(direct-current) power supply apparatus having a control element and a resistive element provided in series with a load.

### BACKGROUND TECHNOLOGY

The following is known as a conventional technique for configuring a direct-current power supply apparatus. That is, a control element is provided in series with a load connected to an output terminal of a direct-current power supply apparatus, and an input voltage supplied externally is dropped by this control element so as to output a predetermined output voltage (See Patent Document 1, for instance). A typical example of the conventional direct-current power supply apparatus is shown in FIG. 6. In this DC power supply apparatus 10, an input voltage V_{I} is inputted to an input terminal IN and then dropped so as to output an output voltage Vₒ from an output terminal OUT. A smoothing capacitor 102 and a load 103 are connected to the output terminal OUT where an output current Iₒ flows. The load 103 is a single or a plurality of electronic apparatuses that achieve a function of electronic equipment on which the DC power supply apparatus 101 is mounted.

A source of a control element 111, which is a PMOS type transistor, is connected to the input terminal IN, whereas a drain of the control element 111 is connected to the output terminal OUT. The voltage at the output terminal OUT is inputted to an error amplifier 115. The error amplifier 115 compares the voltage at the output terminal OUT with a predetermined reference voltage V_{REF}, and amplifies the difference therebetween so as to output a control signal to a gate of the control element 111.

In this DC power supply apparatus 101, an output voltage Vₒ is fed back so as to control the control element 111. Thereby, the output voltage V_{O} is retained at the reference voltage V_{REF}.

[Patent Document 1] Japanese Patent Application Laid-Open No. 2005-93567.

### DISCLOSURE OF THE INVENTION

### Problems to be Solved by the Invention

In Japanese Patent Application Laid-Open No. 2003-380575, filed by the same applicant as the present patent application, which was filed prior to the present application, a DC power supply apparatus is proposed where a resistive element provided, before an output terminal, in series with a control element is used and an output voltage is marginally varied in response to the variation in output current so as to suppress the undershoot or overshoot at the time of variation in the output current and prevent the oscillation phenomenon. Such a DC power supply apparatus is especially effective if a single or a plurality of electronic apparatuses as a load is/are of a digital type where the consumed power varies largely.

FIG. 7 is a circuit diagram of a DC power supply apparatus 104, modified over the above-described DC power supply apparatus 101, where a resistive element 112 is provided before the output terminal OUT. Output current-output voltage characteristics of this DC power supply apparatus 104 are as shown in FIG. 8. That is, as an output current Iₒ increases, an output voltage V_{O} decreases in response to a resistance value (output resistance value) R₁ of the resistive element 112. A maximum output current I_{OMAX} (3A, for instance) and a permissible range of variation (1.485 V to 1.515 V, for instance) are determined by the specifications of an electronic apparatus connected as a load 103. However, it goes without saying that the output voltage V_{O} at the time of the maximum output current I_{OMAX} must lie within the permissible range of variation.

The output current-output voltage characteristics of such a DC power supply apparatus 104 are expressed by the following Equation.

V_{O}=V_{REF}−I_{O}×R₁ (Equation 1)

Since the direction of variation in the output voltage V_{O} that follows the variation in the output current Iₒ is the same as the direction of undershoot or overshoot, this DC power apparatus 104 can control the magnitude of these. Also, the variation in the control signal at the gate of the control element 111 turns out to be small, so that the rotation of phase is small and the oscillation phenomenon can be prevented.

However, it is desired that the resistance value (output resistance value) R₁ of the resistive element 112 provided in the DC power supply apparatus 104 be so adjusted in steps of, for example, 0.1 mΩ as to be suited to the specifications of an electronic apparatus connected as the load 103 or the specification of consumption current and the smoothing capacitor 102. On the other hand, since a large current flows through the resistive element 112, this resistive element 112 must have a high allowable dissipation and low resistance value. Thus, a stand-alone general-purpose resistor is generally used instead of a resistive element incorporated in a semiconductor integrated circuit such as the control element 111. However, the resistor like this has a small number of kinds of resistance values and, for example, the steps of 1 mΩ is only available, which makes it difficult to obtain one having a desired resistance value.

The present invention has been made in view of the foregoing circumstance, and a general purpose thereof is to provide a DC power supply apparatus capable of easily obtaining a desired output resistance value.

### Means for Solving the Problems

In order to resolve the above problems, a DC power supply apparatus according to Claim 1 is a DC power supply apparatus for outputting a predetermined output voltage by lowering an input voltage, and it comprises: a control element to which the input voltage is inputted; a first resistive element, provided in series with the control element, which outputs the output voltage; and a second resistive element and a third resistive element, connected in series with each other, which are provided in parallel with the first resistive element, wherein a voltage at a midpoint between the second resistive element and the third resistive element is fed back to control the control element.

In the DC power supply apparatus according to Claim 1, a DC power supply apparatus of Claim 2 further comprises an error amplifier which compares the voltage from the midpoint between the second resistive element and the third resistive element with a reference voltage, wherein the control element is controlled according to an output of the error amplifier.

In the DC power supply apparatus according to Claim 1 or Claim 2, a DC power supply according of Claim 3 is such that the voltage at a midpoint between the second resistive element and the third resistive element is directly inputted to the error amplifier.

In the DC power supply apparatus according to any one of Claim 1 to Claim 3, a DC power supply apparatus of Claim 4 further comprises a capacitor provided in parallel with the second resistive element.

In the DC power supply apparatus according to any one of Claim 1 to Claim 4, a DC power supply apparatus of Claim 5 is such that at least the control element is integrated on a semiconductor chip of a semiconductor integrated circuit and the first resistive element is a bonding wire.

In the DC power supply apparatus according to Claim 5, a DC power supply apparatus of Claim 6 is such that the second and the third resistive element are externally attached to the semiconductor integrated circuit.

In the DC power supply apparatus according to Claim 5, a DC power supply apparatus of Claim 7 is such that the second and the third resistive element are integrated on the semiconductor chip of a semiconductor integrated circuit.

In the DC power supply apparatus according to Claim 5, a DC power supply apparatus of Claim 8 is such that the second resistive element is integrated on the semiconductor chip of a semiconductor integrated circuit, and the third resistive element is externally attached to the semiconductor integrated circuit.

In the DC power supply apparatus according to Claim 8, the DC power supply apparatus of Claim 9 is such that as temperature rises, a resistance value of the second resistive element increases.

### EFFECTS OF THE INVENTION

According to the present invention, the output resistance value of a DC power supply apparatus is determined by the first, the second and the third resistive element. And the DC power supply apparatus is adjusted by ratios of the second resistive element and the third resistive element. Hence, a desired output resistive value can be easily obtained.

### BRIEF DESCRIPTION OF THE DRAWINGS

FIG. 1 is a circuit diagram showing a DC power supply apparatus according to a preferred embodiment of the present invention.

FIG. 2 is a circuit diagram showing a DC power apparatus which is modified over the above apparatus of FIG. 1.

FIG. 3 is a circuit diagram showing a DC power supply apparatus according to a further preferred embodiment of the present invention.

FIG. 4 is a circuit diagram showing another DC power supply apparatus according to a further preferred embodiment of the present invention.

FIG. 5 is a circuit diagram showing still another DC power supply apparatus according to a further preferred embodiment of the present invention.

FIG. 6 is a circuit diagram showing a typical conventional DC power supply apparatus.

FIG. 7 is a circuit diagram showing a DC power supply apparatus which is modified over the above DC power supply apparatus of FIG. 6.

FIG. 8 shows an output current-output voltage characteristic of the DC power supply apparatus shown in FIG. 7.

### DESCRIPTION OF REFERENCE NUMERALS

1, 1′, 51, 54, 57 DC power supply apparatus, 11 control element, 12 first resistive element, 13 second resistive element, 14 third resistive element, 15 error amplifier, V_{I} input voltage, V_{O} output voltage.

### THE BEST MODE FOR CARRYING OUT THE INVENTION

The best mode for carrying out the present invention will be described hereinbelow. FIG. 1 is a circuit diagram showing a DC power supply apparatus 1 according to a preferred embodiment of the present invention. This DC power supply apparatus 1 drops an input voltage V_{I} (3.3 V, for example) inputted from outside via an input terminal IN so as to output a predetermined output voltage Vₒ (about 1.5 V, for example) from an output terminal OUT. A smoothing capacitor 2 and a load 3 are connected to the output terminal OUT where an output current Iₒ flows. The load 3 is a single or a plurality of electronic apparatuses that achieve a function of electronic equipment on which the DC power supply apparatus 1 is mounted.

In concrete terms, a source (input terminal) of a control element 11, which is a PMOS type transistor, is connected to the input terminal IN, one end of a first resistive element 12 is connected to a drain (output terminal) of the control element 11, and the output terminal OUT is connected to the other end of the first resistive element 12. A second resistive element 13 and a third resistive element 14 are connected in series. One end of the second resistive element 13 and one end of the third resistive element 14 are connected across the first resistive element. That is, the input voltage V_{I} is inputted to the control element 11; the first resistive element 12 is connected in series with the control element 11; and the second and third resistive elements 13 and 14 are connected in parallel with the first resistive element 12. A midpoint between the second resistive element 13 and the third resistive element 14 is inputted to a noninverting input terminal of an error amplifier 15. A predetermined reference voltage V_{REF} is inputted to an inverting input terminal thereof, whereas a gate (control end) of the control element 11 is connected to an output terminal thereof. Accordingly, the error amplifier 15 compares the voltage at the midpoint between the second resistive element 13 and the third resistive element 14 with the reference voltage V_{REF}, and then amplifies the error between them so as to output a control signal. That is, the error amplifier 15 feeds back the voltage at the midpoint between the second resistive element 13 and the third resistive element 14 so as to control the control element 11. The resistance values of the first, second and third resistive elements 12, 13 and 14 are R₁ (30 mΩ, for example), R₂ (20 KΩ, for example) and R₃ (10 KΩ, for example), respectively, where R₂ and R₃ are very large resistance values relative to R₁.

In this DC power supply apparatus 1, a voltage Vₓ at the midpoint between the second resistive element 13 and the third resistive element 14 is expressed by the following Equation.

$${V}_{X} = {V}_{O} + \frac{{I}_{O}}{\frac{1}{{R}_{1}} + \frac{1}{{R}_{2} + {R}_{3}}} \times \frac{{R}_{3}}{{R}_{2} + {R}_{3}} \qquad ( Equation 2 )$$

If a condition that R₂ and R₃ are much larger than R₁ is applied to Equation 2, the following will result.

$${V}_{X} = {V}_{O} + {I}_{O} \times {R}_{1} \times \frac{{R}_{3}}{{R}_{2} + {R}_{3}} \qquad ( Equation 3 )$$

Further, the voltage Vₓ at the midpoint between the second resistive element 13 and the third resistive element 14 is made to agree with a predetermined reference voltage V_{REF} by an operation of the error amplifier 15 and the control element 11. Hence, Equation 3 is changed to the following.

$${V}_{O} = {V}_{REF} - {I}_{O} \times {R}_{1} \times \frac{{R}_{3}}{{R}_{2} + {R}_{3}} \qquad ( Equation 4 )$$

From Equation 4, the output current-output voltage characteristics are as the above-described FIG. 8. As Iₒ increases, the output voltage Vₒ decreases. And the output resistance value becomes R₁×R₃/(R₂+R₃). If, for example, R₁ is 50 mΩ, it is possible for the resistance value to become 0 to 50 mΩ by adjusting the ratio of R₂ or R₃. Accordingly, if a resistor of 50 mΩ with high allowable dissipation and low resistive value is obtained as the first resistive element 12, easily obtainable resistors of large resistance values will be the second and third resistive elements 13 and 14. This allows the output resistance value of the DC power supply apparatus 1 to be 0 to 50 mΩ. In this manner, a desired output resistance value can be easily obtained by using a certain fixed first resistive element 12.

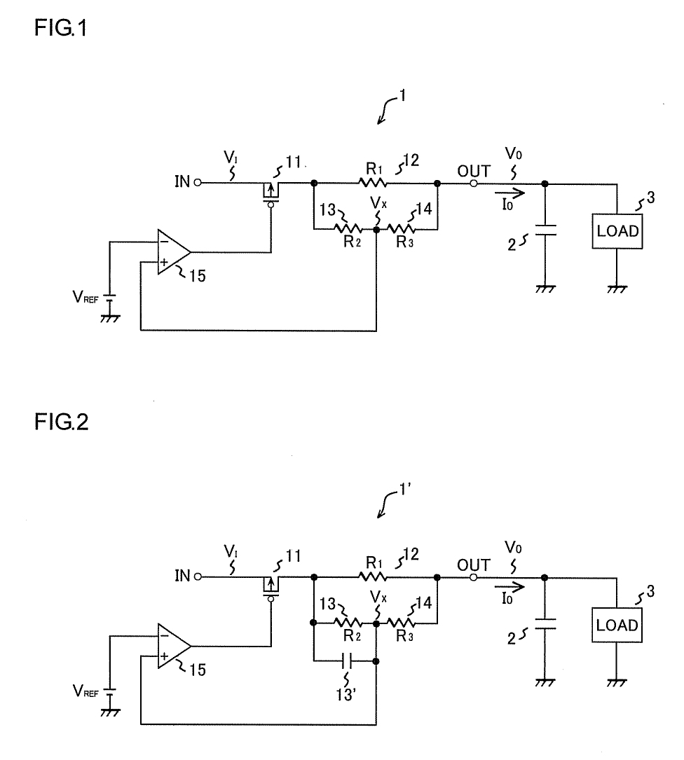

Also, the DC power supply apparatus 1 may be modified so as to have a configuration of a DC power supply apparatus 1′ shown in FIG. 2. In this DC power supply apparatus 1′, there is provided a capacitor 13′ in parallel with the second resistive element 13. Although the total impedance of these two elements nearly equals to R₂ at low frequency, it approaches 0 at high frequency. Hence, the output resistance value of the DC power supply apparatus 1′ is larger as the frequency becomes higher. On the other hand, there are large high-frequency components contained in an undershoot or overshoot. Higher the frequency, the phase tends to rotate more. Thus, the magnitude of the undershoot or overshoot can be further suppressed and the oscillation phenomenon can be all the more prevented.

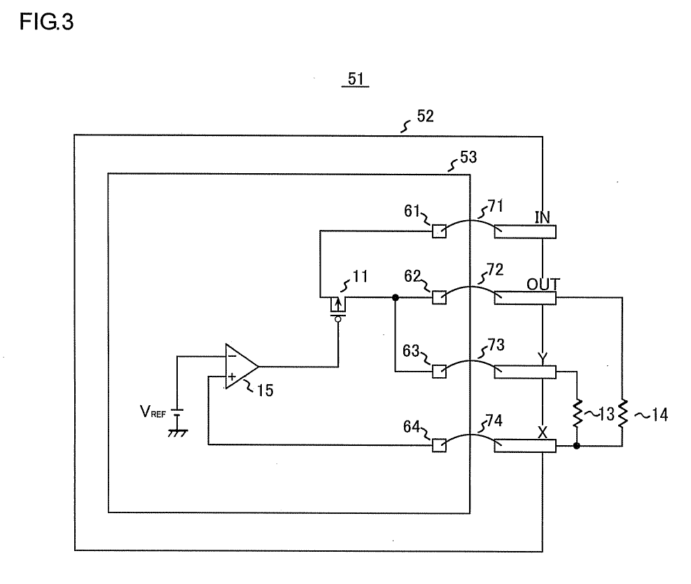

A description is next given of a DC power supply apparatus according to a further preferred embodiment. DC power supply apparatuses shown in FIGS. 3, 4 and 5 are those where part of the above-described DC power supply apparatus 1 is incorporated therein and additional modifications are made.

A DC power supply apparatus 51 includes a semiconductor integrated circuit 52. The semiconductor integrated circuit 52 has four lead terminals IN, OUT, Y and X. The lead terminals IN and OUT correspond respectively to the above-described input terminal IN and the output terminal OUT. The above-described control element 11 and the error amplifier 15 are integrated on a semiconductor chip 53 in the semiconductor integrated circuit 52. The source of the control element 11 is connected to the lead terminal IN via a bonding pad 61 and a bonding wire 71 made of gold, for example. The drain of the control element 11 is connected to the lead terminal OUT via a bonding pad 62 and a bonding wire 72, and is connected to the lead terminal Y via a bonding pad 63 and a bonding wire 73. The noninverting input terminal of the error amplifier 15 is connected to the lead terminal X via a bonding pad 64 and a bonding wire 74.

The DC power supply apparatus 51 includes the above-described second and third resistive elements 13 and 14 which are resistors externally attached to the semiconductor integrated circuit 52. The second resistive element 13 is provided between the lead terminal Y and the lead terminal X, whereas the third resistive element 14 is provided between the lead terminal OUT and the lead terminal X.

Special attention shall be focused on the following point here. That is, the DC power supply apparatus 51 utilizes the bonding wire 72 as the first resistive element. Although the resistance value of a bonding wire depends on the thickness or length thereof, it is about 50 mΩ to 100 mΩ. It is extremely difficult to set beforehand the resistance value of a bonding wire to a desired value. Accordingly, if, as described above, the resistance value of a bonding wire is, for example, 50 mΩ, then 0 to 50 mΩ will be feasible as the output resistance value by adjusting the ratio of the resistance values of the second and third resistive elements 13 and 14. Similarly, if the resistance value of the bonding wire 72 is 100 mΩ, then 0 to 100 mΩ will become feasible as the output resistance value. It is to be noted that the resistance values of other bonding wires 71, 73 and 74 have little effect on the output resistance values. This is because the bonding wire 71 does not lie at a side of the drain but at a side of the source of the control element 11 where the voltage is controlled and also because the resistance values of the bonding wires 73 and 74 are much smaller than those of the resistive elements 13 and 14. In many cases, the input voltage V_{I} inputted to the lead terminal IN serves as a supply voltage for the error amplifier 15 or other circuits (not shown). Thus, it is desirable that a plurality of bonding wires be provided in parallel in order to lower the resistance value of the bonding wire 71 as much as possible.

In this manner, the DC power supply apparatus 51 can easily obtain a desired output resistance value. Also, although a stand-alone resistor of high allowable dissipation and low resistive value is generally costly and has a large size, such a resistor as this is not used. Hence, the reduction in cost and the smaller size in electronic equipment become possible.

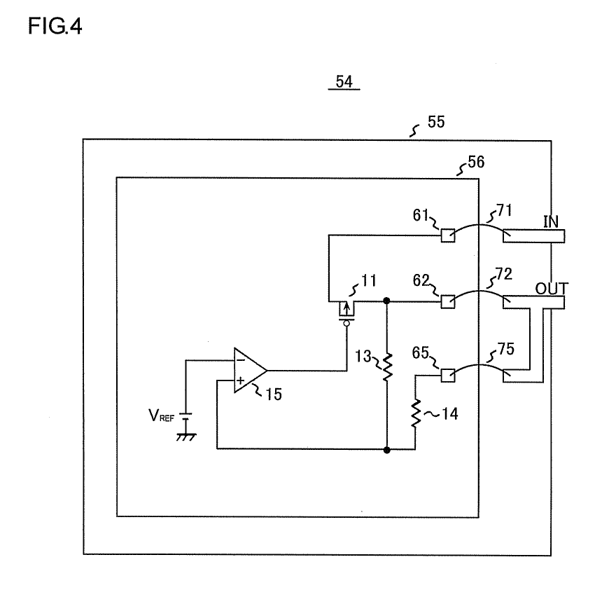

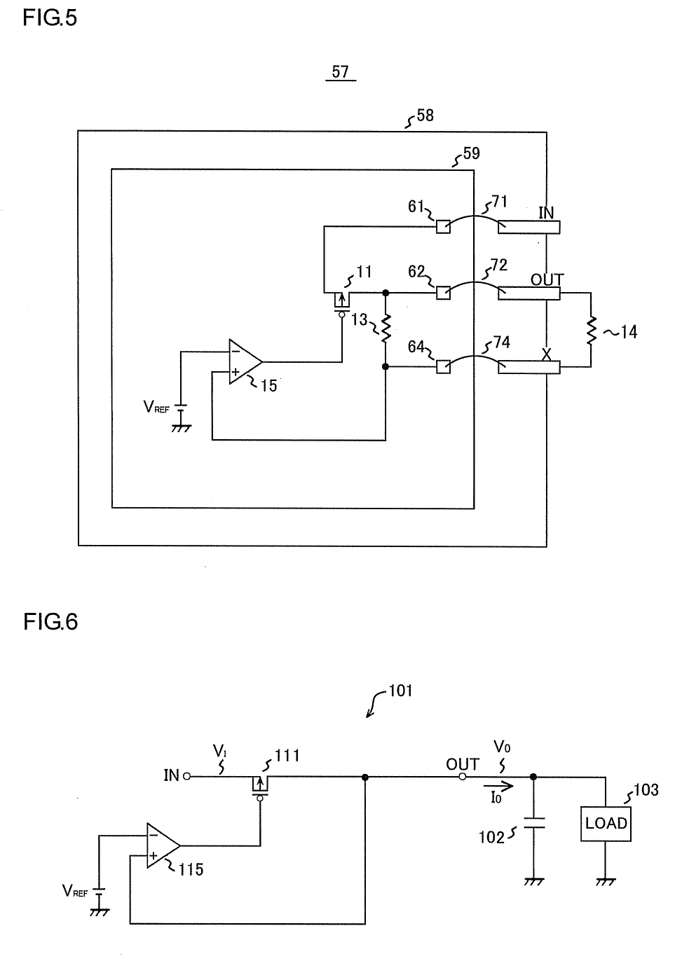

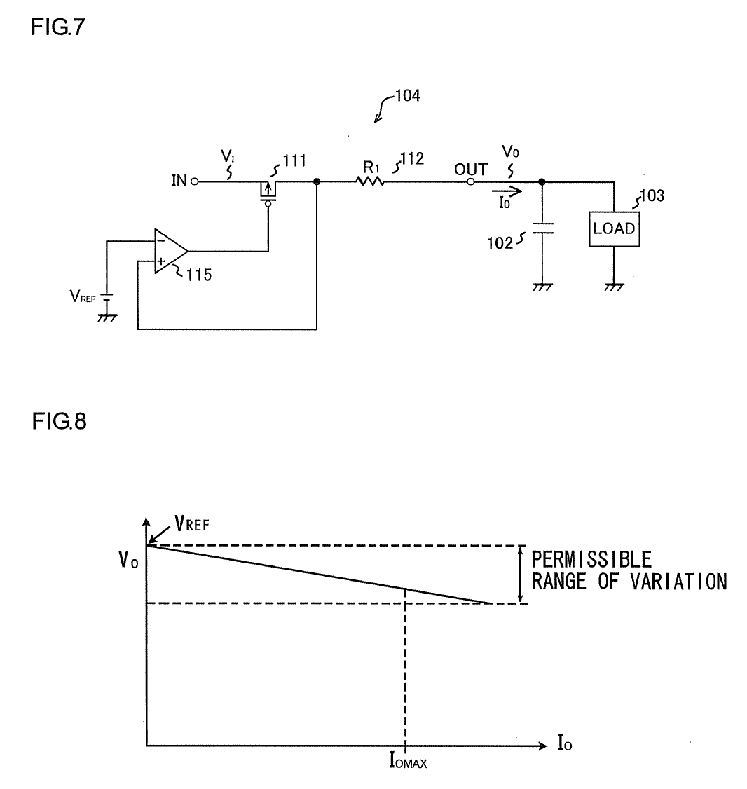

A DC power supply apparatus 54 shown in FIG. 4 includes a semiconductor integrated circuit 55. The semiconductor integrated circuit 55 has two lead terminals IN and OUT. The control element 11, the error amplifier 15, and the second and third resistive elements 13 and 14 are integrated on a semiconductor chip 56 in the semiconductor integrated circuit 55. The source of the control element 11 is connected to the lead terminal IN via a bonding pad 61 and a bonding wire 71. The drain of the control element 11 is connected to the lead terminal OUT via a bonding pad 62 and a bonding wire 72, and is connected to one end of the resistive element 13 on the semiconductor chip 56. The noninverting input terminal of the error amplifier 15 is connected to the other end of the second resistive element 13 and one end of the resistive element 14. The other end of the third resistive element 14 is connected to the lead terminal OUT via a bonding pad 65 and a bonding wire 75. In this apparatus, too, the bonding wire 72 is utilized as the first resistive element.

Similar to the above-described DC power supply apparatus 51, this DC power supply apparatus 54 can easily obtain a desired output value. Compared with the DC power supply apparatus 51, the number of lead terminals is less by two and there is no externally attached resistors. This makes it possible to achieve further reduction in cost. However, since the second and third resistive elements 13 and 14 are provided on the semiconductor chip 56, it is desired to be used for a case where the variation in the resistive value of the bonding wire 72 between individual packaged semiconductors is very small and no adjustment is required for the second and third resistive elements 13 and 14 or the trimming by laser or the like is possible.

A DC power supply apparatus 57 shown in FIG. 5 includes a semiconductor integrated circuit 58. The semiconductor integrated circuit 58 has three lead terminals IN, OUT and X. The control element 11, the error amplifier 15 and the second resistive element 13 are integrated on a semiconductor chip 59 in the semiconductor integrated circuit 58. The source of the control element 11 is connected to the lead terminal IN via a bonding pad 61 and a bonding wire 71. The drain of the control element 11 is connected to the lead terminal OUT via a bonding pad 62 and a bonding wire 72, and is connected to one end of the second resistive element 13 on the semiconductor chip 59. The noninverting input terminal of the error amplifier 15 is connected to the other end of the second resistive element 13 and is connected to the lead terminal X via a bonding pad 64 and a bonding wire 74. In this apparatus, too, the bonding wire 72 is utilized as the first resistive element.

The DC power supply apparatus 57 includes also the third resistive element 14 which is a resistor externally attached to the semiconductor integrated circuit 58. The third resistive element 14 is provided between the lead terminal OUT and the lead terminal X.

Similar to the above-described DC power supply apparatuses 51 and 54, this DC power supply apparatus 57 can easily obtain a desired output value. Compared with the DC power supply apparatus 51, the number of lead terminals is less by one and there is provided a single external resistor. This makes it possible to reduce the cost. Also, the output resistive value can be adjusted by adjusting the third resistive element 14. However, the adjustable range of the output resistive values is narrower as compared with the DC power supply apparatus 51.

As the temperature rises, the resistance value of a bonding wire increases. In the DC power supply apparatus 57, if the second resistive element 13 is provided so that the resistive value thereof increase along with the increase in temperature (for example, if the second resistive element 13 is formed in a diffusion layer), the temperature characteristic thereof will be brought close to that of the bonding wire 72 which is the first resistive element. This may suppress the variation in the output resistance value of the bonding wire 72 due to the variation in the resistance value caused by temperature.

While a description has been given of DC power supply apparatuses according to the preferred embodiments of the present invention, such description is for illustrative purposes only, and it is to be understood that changes and variations in design may be made without departing from the spirit or scope of the appended Claims. For example, in the embodiments the voltage at the midpoint between the second resistive element 13 and the third resistive element 14 is directly inputted to the error amplifier 15. However, it is also possible to input the voltage attenuated by an attenuator. Although a PMOS type transistor is used for the control element 11 in the embodiments, an NMOS type transistor, a bipolar transistor or the like can be used. Although a series regular has been described in the embodiments, the present invention is applicable to other regulators.

### INDUSTRIAL APPLICABILITY

The present invention can be used for a DC power supply apparatus which generates DC output voltage so as to be supplied to a load.

1. A direct-current power supply apparatus for outputting a predetermined output voltage by lowering an input voltage, the apparatus comprising:
a control element to which the input voltage is inputted;
a first resistive element, provided in series with said control element, which outputs the output voltage; and
a second resistive element and a third resistive element, connected in series with each other, which are provided in parallel with said first resistive element,
wherein a voltage at a midpoint between said second resistive element and said third resistive element is fed back to control said control element.

2. A direct-current power supply apparatus according to claim 1, further comprising an error amplifier which compares the voltage from the midpoint between said second resistive element and said third resistive element with a reference voltage,
wherein said control element is controlled according to an output of said error amplifier.

3. A direct-current power supply according to claim 2, wherein the voltage at a midpoint between said second resistive element and said third resistive element is directly inputted to said error amplifier.

4. A direct-current power supply apparatus according to claim 1, further comprising a capacitor provided in parallel with said second resistive element.

5. A direct-current power supply apparatus according to claim 1, wherein at least said control element is integrated on a semiconductor chip of a semiconductor integrated circuit and said first resistive element is a bonding wire.

6. A direct-current power supply apparatus according to claim 5, wherein said second and said third resistive element are externally attached to the semiconductor integrated circuit.

7. A direct-current power supply apparatus according to claim 5, wherein said second and said third resistive element are integrated on the semiconductor chip of a semiconductor integrated circuit.

8. A direct-current power supply apparatus according to claim 5, wherein said second resistive element is integrated on the semiconductor chip of a semiconductor integrated circuit, and
wherein said third resistive element is externally attached to the semiconductor integrated circuit.

9. A direct-current power supply apparatus according to claim 8, wherein as temperature rises, a resistance value of said second resistive element increases.
